(19) United States
(12) Patent Application Publication
(10) Pub. No.: US 2022/0244581 A1
(43) Pub. Date: Aug. 4, 2022

(54) ELECTRO-OPTIC MODULATOR

(71) Applicant: ROCKLEY PHOTONICS LIMITED, Altrincham,Cheshire (GB)

(72) Inventor: Adam SCOFIELD, Los Angeles, CA (US)

(21) Appl. No.: 17/629,299

(22) PCT Filed: Jul. 23, 2020
(86) PCT No.: PCT/EP2020/070866

§ 371 Date: Jan. 21, 2022

Related U.S. Application Data
(60) Provisional application No. 62/878,168, filed on Jul. 24, 2019.
(60) Provisional application No. 62/938,830, filed on Nov. 21, 2019.

(51) Int. Cl. G02F 1/025

(52) U.S. Cl. CPC G02F 1/025

(57) ABSTRACT

A metal-oxide semiconductor capacitor, MOSCAP, based electro-optic modulator. The modulator comprising: an input waveguide; a modulating region, coupled to the input waveguide; and an output waveguide, coupled to the modulating region. The modulating region includes an n-i-p-n junction, the n-i-p-n junction comprising: a first n doped region, spaced from a p doped region by an intrinsic region, and a second n doped region, separated from the intrinsic region by the p doped region and on an opposing side of the intrinsic region to the first n doped region.

### FIELD OF THE INVENTION

The present invention relates to an electro-optic modulator.

### BACKGROUND

Metal-oxide semiconductor capacitor (MOSCAP) based modulators typically have a large capacitance due to a thin dielectric layer forming the capacitor region. A larger capacitance slows the modulator, due to the large amount of charge to be dissipated.

Modulation efficiency increases with thinner electric, however this is at the cost of increased capacitance. Therefore, in order to achieve a high bandwidth, the series resistance of the modulator must be made as small as practicable.

In known examples of MOSCAP modulators, a p-i-n junction is formed, in which either: a lower doped (n or p) region is vertically separated from an upper doped (p or n) region by a laterally extending insulator layer; or a left hand doped (n or p) region is laterally separated from a right hand doped (p or n) region by a vertically extending insulator layer.

However, semiconductors usable in silicon photonic applications have a hole mobility which is an order of magnitude lower than silicon. This lower hole mobility results in a higher resistance, and so a higher optical loss for the same doping density. This means that the p-side of the MOSCAP device limits the overall performance. If an n-i-n junction is provided, the modulation efficiency is low due to a lack of carrier accumulation and depletion at the interface.

### SUMMARY

In a first aspect, embodiments of the present invention provide a metal-oxide semiconductor capacitor, MOSCAP, based electro-optic modulator, comprising:
an input waveguide;
a modulating region, coupled to the input waveguide; and
an output waveguide, coupled to the modulating region;

wherein the modulating region includes an n-i-p-n junction, the n-i-p-n junction comprising:
a first n doped region, spaced from a p doped region by an intrinsic region, and a second n doped region, separated from the intrinsic region by the p doped region and on an opposing side of the intrinsic region to the first n doped region.

Retaining the p region yields a high modulation efficiency, and the second n doped region reduces the series resistance.

The MOSCAP modulator may have any one or, to the extent that they are compatible, any combination of the following optional features.

The n doped region may be doped with any one of: phosphorus, arsenic, antimony, bismuth, and lithium. The p doped region may be doped with any one of: boron, aluminium, gallium, and indium.

The p doped region may be thinner than either or both of the first n doped region or the second n doped region. The p doped region may have a thickness equal to a thickness of the intrinsic region. By providing a p doped region so dimensioned, a high field is provided for carrier modulation is provided. A wider n-doped region provides lower access resistance.

The p doped region may be less than 200 nm thick. The p doped region may be less than 100 nm thick.

The intrinsic region may be formed of an oxide.

The MOSCAP modulator may further comprise a first electrode, connected to the first n doped region, and a second electrode, connected to the second n doped region.

The intrinsic region may extend at an oblique angle across the modulating region.

The n-i-p-n junction may be a vertical junction, in that the first n doped region is a lowermost layer and the second n doped region is an uppermost layer.

The n-i-p-n junction may be a horizontal junction, in that the first n doped region is on a first lateral side of the modulator and the second n doped region is on a second lateral side of the modulator.

The modulator may have an operational bandwidth within the range 30 GHz to 40 GHz.

The first n doped region, the second n doped region, and the p doped region may be formed of a same semiconductor material.

The first n doped region may be formed of a different semiconductor material than the second n doped region and the p doped region.

At least one of the first n doped region, second n doped region, and p doped region may be formed of a III-V semiconductor. The III-V semiconductor may be indium phosphide.

In a second aspect, embodiments of the invention provide a method for fabricating a MOSCAP modulator, the method comprising, on a substrate:
growing a first semiconductor region, and doping it with an n type dopant to form a first n doped region;
growing an insulator on a first surface of the first n doped region;
growing a second semiconductor region, on a second surface of the insulator, the first surface opposing the second;
doping a first part of the second semiconductor region with a p type dopant to form a p doped region adjacent to the insulator; and
doping a second part of the second semiconductor region with an n type dopant to form an n doped region adjacent to the p doped region.

The method may have any one, or any combination insofar as they are compatible, of the optional features of the first aspect.

In a third aspect, embodiments of the invention provide a MOSCAP modulator fabricated according to the second aspect.

### BRIEF DESCRIPTION OF THE DRAWINGS

Embodiments of the invention will now be described by way of example with reference to the accompanying drawings in which:

FIG. 1 shows a MOSCAP modulator, including a vertical n-i-p-n junction;

FIG. 2 shows a MOSCAP modulator, including a horizontal n-i-p-n junction;

FIG. 3 shows a MOSCAP modulator, including an oblique n-i-p-n junction;

FIG. 4 is a plot showing the difference in bandwidths between an n-i-p junction and an n-i-p-n junction;

FIGS. 5A and 5B are plots of band structure for an n-i-p junction and an n-i-p-n junction respectively; and

FIGS. 6A and 6B are plots of charge accumulation for an n-i-p junction and an n-i-p-n junction respectively.

### DETAILED DESCRIPTION AND FURTHER OPTIONAL FEATURES

Aspects and embodiments of the present invention will now be discussed with reference to the accompanying figures. Further aspects and embodiments will be apparent to those skilled in the art.

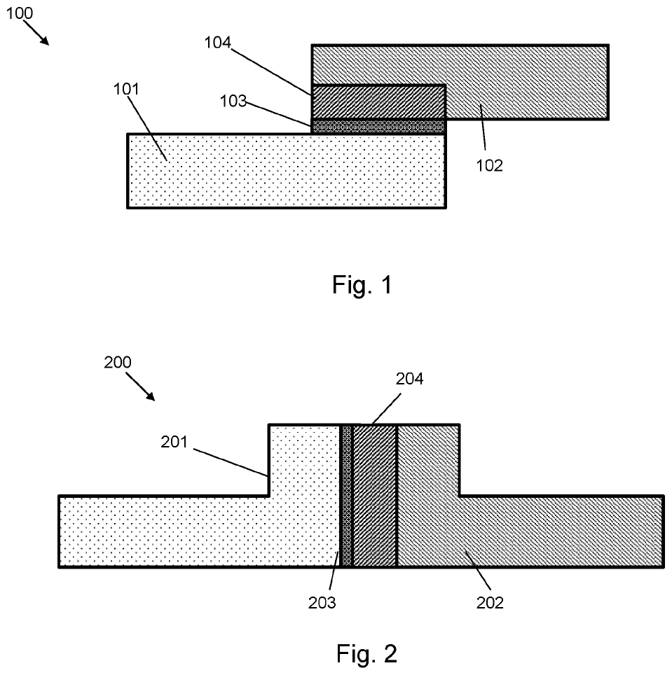

FIG. 1 shows a MOSCAP modulator 100, including a vertical n-i-p-n junction. The junction comprises a first n doped region 101, in this example a layer of semiconductor extending horizontally (i.e. in line with a substrate, not shown). The first n doped region 101 is vertically spaced from a second n doped region 102 by an insulator 103 and p doped region 104. The insulator is an oxide, e.g. silicon dioxide, and the n and p doped regions may be formed of silicon or silicon germanium.

A modulator according to FIG. 1 would typically be made on a wafer. A first semiconductor layer would be doped, and then etched to provide the first n doped region 101. A cladding or insulator material would be grown to the right of the n doped region 101, i.e. below the region where the second n doped region 102 is provided. Next, an oxide layer would be formed atop both the first n doped region and the cladding or insulator material, and the left and side etched back to define the insulator 103. A further semiconductor layer would be grown or deposited, and then doped with n and p type dopants. The p doped region can be formed, for example, by deep implantation of dopants. The further semiconductor layer would be etched back to define the second n doped region 104 and p doped region 103.

FIG. 2 shows a MOSCAP modulator, including a horizontal n-i-p-n junction. The junction comprises a first n doped region 202, in this example a layer of semiconductor extending horizontally but also with a vertically extending section (extending away from the substrate). The first n doped region 202 is horizontally spaced from a second n doped region 202 by an insulator 203 and p doped region 204. Again, the insulator is an oxide, e.g. silicon dioxide, and the p and n doped regions may be formed of silicon or silicon germanium. In a variant of FIG. 2, not shown, the first n doped region, second n doped region, p doped region, and insulator, all have the same height (i.e. vertical extension).

A modulator according to FIG. 2 would also typically be made on a wafer, a first semiconductor layer would be etched away to provide the geometry of the first n doped region 201, and would then be doped to provide the first n doped region 201. Next, via oxidation, deposition, or another method, the insulator layer 203 would be provided. Subsequently, a further conductor would be deposited and optionally etched to provide the geometry of the p doped region 204 and second n doped region 202. P and n dopants are then deposited to provide the p doped region 204 and second n doped region 202.

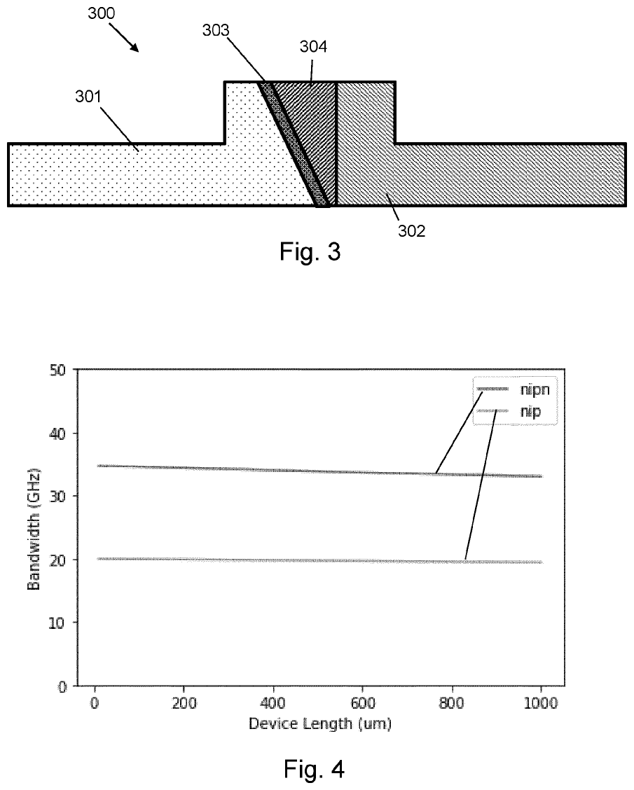

FIG. 3 shows a MOSCAP modulator, including an oblique n-i-p-n junction. The junction comprises a first n doped 301 region, in this example a layer of semiconductor extending horizontally but also with a vertically extending section (extending away from the substrate). The first n doped region 301 is horizontally and vertically spaced from a second n doped region 302 by an insulator 303 and p doped region 304. The interface between the insulator 303 and p doped region 304 is oblique, in that it extends in both a vertical and horizontal direction. Similarly, the interface between the insulator 303 and the first n doped region 301 is also oblique. In this example, the interface between the p doped region 304 and second n doped region 302 is not oblique, in that it extends purely in a vertical direction. However the interface between the p doped region 304 and the second n doped region may be oblique, and may have the same angle as the interface between the insulator 303 and the first n doped region 301.

A modulator according to FIG. 3 may be made using a similar method to that discussed with respect to FIG. 2. However, in this instance, a selective etch would be used to produce the oblique interface between the first n doped region 301 and the insulator 303. Such a selective etch may use the property that some etching techniques have a preferred crystallographic plane along which they etch. After this selective etch, the insulator 303, p doped region 304 and second n doped region 302 can be produced as discussed above. In an example where the interface between the p doped region 304 and second n doped region 302 is oblique, the p type dopants may be implanted at an angle other than 90° in order to produce this oblique interface.

The modulators shown in FIGS. 1-3 are present in waveguides. In some examples the waveguides are ridge waveguides in that the optical mode is chiefly confined in an upper ridge portion of the waveguide (as opposed to a lower slab portion of the waveguide). In other examples, the waveguides are rib waveguides, in that the topical mode is chiefly confined in a slab portion and guided by an upper rib portion.

In the modulators shown in FIGS. 1-3, the first and second n doped regions, as well as the p doped region, may be formed from a same semiconductor material (e.g. silicon, silicon germanium, a III-V semiconductor, indium phosphide, etc.). Alternatively, the first and second n doped regions may be formed from different semiconductor materials. For example, the first n doped region may be formed from silicon or silicon germanium, and the second n doped region may be formed from indium phosphide or another III-V semiconductor. The p doped region is typically formed of the same semiconductor material as the second n doped region, but may be formed of a different semiconductor material.

FIG. 4 is a plot showing the difference in bandwidths between an n-i-p junction and an n-i-p-n junction. As can be seen, moving from an n-i-p to n-i-p-n junction yields a 50% increase in bandwidth for an identically thick oxide thickness (and so capacitance).

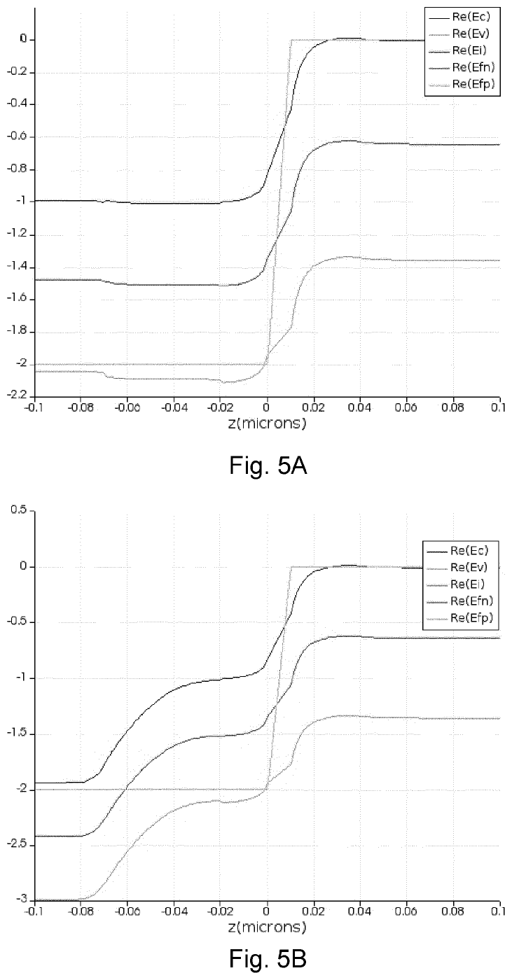

FIGS. 5A and 5B are plots of band structure for an n-i-p junction and an n-i-p-n junction respectively. The plots are of energy (y axis, e.g. electronvolt) against position in the modulator (z, measured in microns). The lines representing various bands: Ec—conduction band, Ev—valence band; Ei—intrinsic Fermi level; Efn—electron Fermi level; and Efp—hole Fermi level.

Notably, the gradient of the slope around 0 microns (i.e. in the junction) determines the electric field strength of the modulator, which influences the efficiency. This electric field is generated by the juxtaposition of an n doped region and a p doped region as is known. It can be seen then that the electric field strength at the junction for the n-i-p junction is similar to that for the n-i-p-n junction, both demonstrating a similar change in energy.

Advantageously then, the provision of the second n doped region gives better conductivity and so a faster response time than an n-i-p junction, whilst also maintaining a similar level of field strength and so efficiency.

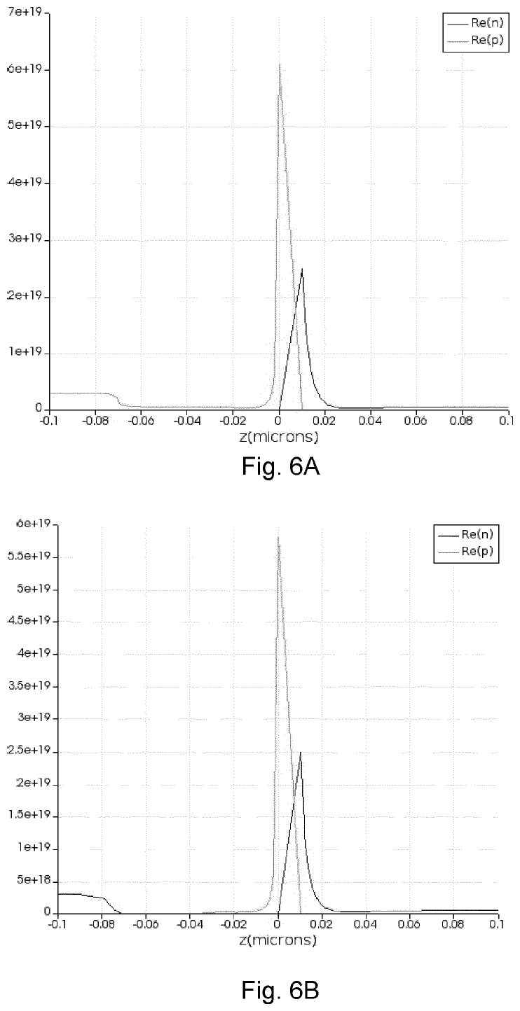

FIGS. 6A and 6B are plots of charge accumulation for an n-i-p junction and an n-i-p-n junction respectively. The y axis of the plots showing charge carrier number, and the x axis showing position in the modulator (0 being at the junction). As can be seen, despite the addition of a further n doped region a similar number of charge carriers are present at the interface of the n-i-p-n junction as compared to the n-i-p junction.

While the invention has been described in conjunction with the exemplary embodiments described above, many equivalent modifications and variations will be apparent to those skilled in the art when given this disclosure. Accordingly, the exemplary embodiments of the invention set forth above are considered to be illustrative and not limiting. Various changes to the described embodiments may be made without departing from the spirit and scope of the invention.

1. A metal-oxide semiconductor capacitor, MOSCAP, based electro-optic modulator, comprising:
an input waveguide;
a modulating region, coupled to the input waveguide; and
an output waveguide, coupled to the modulating region,
wherein the modulating region includes an n-i-p-n junction, the n-i-p-n junction comprising:
a first n doped region, spaced from a p doped region by an intrinsic region, and a second n doped region, separated from the intrinsic region by the p doped region and on an opposing side of the intrinsic region to the first n doped region.

2. The MOSCAP modulator of claim 1, wherein the p doped region is thinner than the first n doped region, the second n doped region, or both the first n doped region and the second n doped region.

3. The MOSCAP modulator of claim 1, wherein the p doped region has a thickness equal to a thickness of the intrinsic region.

4. The MOSCAP modulator of claim 1, wherein the p doped region is less than 200 nm thick.

5. The MOSCAP modulator of claim 1, wherein the p doped region is less than 100 nm thick.

6. The MOSCAP modulator of claim 1, wherein the intrinsic region is formed of an oxide.

7. The MOSCAP modulator of claim 1, further comprising a first electrode, connected to the first n doped region, and a second electrode, connected to the second n doped region.

8. The MOSCAP modulator of claim 1, wherein the intrinsic region extends at an oblique angle across the modulating region.

9. The MOSCAP modulator of claim 1, wherein the n-i-p-n junction is a vertical junction, such that the first n doped region is a lowermost layer, and the second n doped region is an uppermost layer.

10. The MOSCAP modulator of claim 1, wherein the n-i-p-n junction is a horizontal junction, in that the first n doped region is on a first lateral side of the modulator, and the second n doped region is on a second lateral side of the modulator.

11. The MOSCAP modulator of claim 1, wherein the modulator has an operational bandwidth within the range 30 GHz to 40 GHz.

12. The MOSCAP modulator of claim 1, wherein the first n doped region, second n doped region, and p doped region are formed of a same semiconductor material.

13. The MOSCAP modulator of claim 1, wherein the first n doped region is formed of a different semiconductor material than the second n doped region and p doped region.

14. The MOSCAP modulator of claim 1, wherein at least one of the first n doped region, second n doped region, and p doped region is formed of a III-V semiconductor.

15. The MOSCAP modulator of claim 14, wherein the III-V semiconductor is indium phosphide.

16. A method for fabricating a MOSCAP modulator, the method comprising, on a substrate, steps of:
growing a first semiconductor region, and doping it with an n type dopant to form a first n doped region;
growing an insulator on a first surface of the first n doped region;
growing a second semiconductor region, on a second surface of the insulator, the first surface opposing the second surface;
doping a first part of the second semiconductor region with a p type dopant to form a p doped region adjacent to the insulator; and
doping a second part of the second semiconductor region with an n type dopant to form an n doped region adjacent to the p doped region.
